(19) United States
(12) Patent Application Publication
(10) Pub. No.: US 2017/0127140 A1
(43) Pub. Date: May 4, 2017

(54) METHOD AND SYSTEM FOR REMINDING APPOINTMENT OF LIVE PROGRAMS AND COMPUTER-READABLE MEDIUM

(71) Applicants: Le Holdings (Beijing) Co., Ltd., Beijing (CN); Le Shi Zhi Xin Electronic Technology (Tianjin) Limited, Tianjin (CN)

(72) Inventor: Rong Li, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/242,131

(22) Filed: Aug. 19, 2016

Related U.S. Application Data
(63) Continuation of application No. PCT/CN2016/086840, filed on Jun. 23, 2016.

(30) Foreign Application Priority Data
Nov. 2, 2015 (CN) 201510735930.6

(51) Int. Cl. H04N 21/488; H04N 21/234; H04N 21/845; H04N 21/2668

(52) U.S. Cl. CPC H04N 21/4882; H04N 21/2668; H04N 21/23424; H04N 21/845

(57) ABSTRACT

Disclosed are a method and device for reminding appointment of live programs, and a computer-readable medium, wherein the method includes: receiving a request for a predetermined live program; setting an advanced-reminding time for the predetermined live program via a system alarm clock according to the request; and prompting a user to watch or cancel the predetermined live program when reaching the advanced-reminding time. By employing the above technical solution of the present application, the appointed live programs can be reminded via the system alarm clock, so that an additional application is avoided being installed in a user terminal to remind an appointed program, thus greatly enhancing the convenience for the user to watch the live program and avoiding too much memory from being occupied in the meanwhile.

### CROSS REFERENCE TO RELATED APPLICATIONS

This application is a continuation of International Application No. PCT/CN2016/086840, filed on Jun. 23, 2016, which is based upon and claims priority to Chinese Patent Application No. 201510735930.6, filed on Nov. 2, 2015, the entire contents of which are incorporated herein by reference.

### TECHNICAL FIELD

The disclosure relates to the appointment of live programs, and more particularly, to a method and a device for reminding appointment of live programs and a computer-readable medium.

### BACKGROUND

With the wide application of smart TVs and network live broadcast, a user may also fail to watch a video that is expected to be watched accurately and quickly due to excessive optional resources while enjoying a vast number of video resources. For instance, if the user has to go to the United States on Tuesday, but there is a live World Cup on Thursday, then the user has only to initiatively wait for the start of playing the World Cup on Thursday on schedule. If the user forgets the live World Cup Soccer game on Thursday, then the user is prone to miss watching the World Cup.

To overcome the above-mentioned problems, it is necessary to provide a novel method and a novel device for reminding appointment of live programs.

### SUMMARY

The present invention provides a method and a device for reminding appointment of live programs.

According to a first aspect, the present invention provides a method for reminding appointment of live programs, includes the following steps: receiving a request for a predetermined live program; setting an advanced-reminding time for the predetermined live program via a system alarm clock according to the request; and prompting a user to watch or cancel the predetermined live program when reaching the advanced-reminding time.

According to a second aspect, the present invention also provides a device for reminding appointment of live programs, including: at least one processor; and a memory communicably connected with the at least one processor for storing instructions executable by the at least one processor, wherein execution of the instructions by the at least one processor causes the at least one processor to: receive a request for a predetermined live program; set an advanced-reminding time for the predetermined live program via a system alarm clock according to the request; and prompt a user to watch or cancel the predetermined live program when reaching the advanced-reminding time.

According to a third aspect, the present invention provides a non-volatile computer-readable storage medium, where the non-volatile computer-readable storage medium stores a computer instruction, and a computer executes the computer instruction to execute the following operations: receiving a request for a predetermined live program; setting an advanced-reminding time for the predetermined live program via a system alarm clock according to the request; and prompting a user to watch or cancel the predetermined live program when reaching the advanced-reminding time.

By employing the technical solution of the present application, the appointed live program may be reminded via the system alarm clock, so that an additional application (APP) is avoided being installed in a user terminal to remind an appointed program, thus greatly enhancing the convenience for the user to watch the live program and avoiding too much memory from being occupied in the meanwhile.

### BRIEF DESCRIPTION OF THE DRAWINGS

In order to explain the technical solutions in the detailed embodiments of the present invention more clearly, the drawings used in the embodiment description will be simply introduced hereinafter. It is apparent that the drawings described hereinafter merely represent some embodiments of the present invention, and those having ordinary skills in the art may also obtain other drawings according to these drawings without going through creative work.

FIG. 1 is a flow chart of one embodiment of a method for reminding appointment of live programs of the present application; and

FIG. 2 is a block diagram of one embodiment of a device for reminding appointment of live programs of the present application.

FIG. 3 is a hardware structure diagram of an electronic device for performing the method for reminding appointment of live programs according to one embodiment of the present disclosure.

### DETAILED DESCRIPTION

The specific embodiments of the present invention will be described clearly and completely hereinafter with reference to the accompanying drawings. Apparently, the embodiments described are some, but not all embodiments of the present invention. All the other embodiments derived by those having ordinary skills in the art on the basis of the embodiments of the present invention without going through creative efforts shall all fall within the protection scope of the present invention. The technical features involved in different embodiments of the present invention described herein may be combined mutually as long as no conflictions are constituted there among.

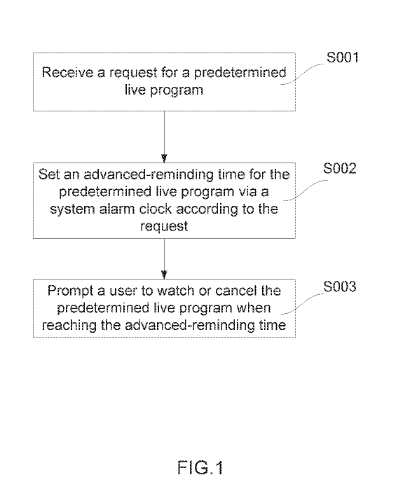

FIG. 1 is a flow chart of one embodiment of a method for reminding appointment of live programs of the present application. As illustrated in FIG. 1, the method for reminding appointment of live programs of the present application includes the following steps.

In step S001: receiving a request for a predetermined live program.

In step S002: setting an advanced-reminding time for the predetermined live program via a system alarm clock according to the request.

In step S003: prompting a user to watch or cancel the predetermined live program when reaching the advanced-reminding time.

In step S001, the request for the predetermined live program is received. In one embodiment of the present application, the user may initiate a request for a predetermined program via a program list in a user terminal, including setting information of the predetermined program. The user information refers to account information of a user having logged in the user terminal, and the account information may include a mobile phone number of the user and the like. The information of the predetermined program includes a name and a play time of the predetermined program, as well as a channel playing the predetermined program, etc. After receiving the request initiated by the user, the terminal may confirm which program the user wishes to watch. The user terminal may be a wireless terminal or a wired terminal, wherein the wireless terminal may refer to a device having a wireless connection function, or a device connecting to a wireless modem and providing a voice and/or data communication to a user. The wireless terminal may carry out communications with one or more core networks through a wireless access network. The wireless terminal may be a mobile terminal, such as a mobile phone (or called as a “honeycomb” phone) and a computer having a mobile terminal. For instance, it may be a portable, pocket-sized, handheld, computer built-in or vehicle-mounted mobile device.

In step S002, the advanced-reminding time for the predetermined program is set via a system alarm clock according to the request. In particular, the setting of the advanced-reminding in the present application is specifically achieved via the system alarm clock, which may fully utilize the resources of the system, without the need for installing an additional application. Therefore, the memory consumption of the system is saved and the wasting of resources is avoided. In addition, the reminding time of the predetermined program is determined according to the information of the predetermined program (for instance, the name, the play time and the like of the predetermined program). The reminding time of the predetermined program refers to a specific time before the predetermined program play time, for instance, the reminding time is set as two minutes before the predetermined program play time in one embodiment of the present application. During the specific operation, the user sets the predetermined program via a terminal, and the terminal will automatically determine the reminding time of the predetermined program. For instance, with regard to a predetermined program “Super Brain” having a play time at 20:30 on Dec. 21, 2015, the user may select the predetermined program “Super Brain” via a terminal according to a program list, and the terminal will determine the reminding time of the predetermined program according to the information thereof after receiving the predetermined request. For instance, the terminal is automatically set to carry out the predetermined reminder at 20:28 via the system alarm clock according to the predetermined information after receiving a request of scheduling the “Super Brain” having a play time at 20:30 on December 21 by the user. In one embodiment of the present application, the reminder of the predetermined program may be executed in the forms of a ring tone, a vibration, displaying prompt message on a display screen, or sending the prompt message to a user's terminal (for instance, a mobile phone), wherein the prompt message, for instance, may include a name, a play channel and a play time and the like of the predetermined program. The combination of at least two of the above-mentioned forms, of course, may also be employed for conducting reminder.

In addition, the information of the predetermined program and the setting of the advanced-reminding are stored in a memory. To be specific, the user information, and the information and reminding time of the predetermined program are stored in the memory. The memory may refer to various apparatuses or devices, which may access programs or data and may also automatically access programs or data at a high speed in the running process.

In step S003, a user is prompted to watch or cancel the predetermined live program when reaching the advanced-reminding time. To be specific, the advanced-reminding function is activated when reaching the reminding time of the predetermined program, so that a user may select to watch or cancel the predetermined live program. For instance, with respect to the predetermined program having a play time at 20:30 on Dec. 21, 2015 and a set reminding time at 20:28 on Dec. 21, 2015, the advanced-reminding function is activated when the time reaches 20:28 on Dec. 21, 2015. If the user confirms to watch the predetermined program, the data is analyzed and the channel where the scheduled program will be played is skipped to; while if the user cancels the watching of the predetermined program when the advanced-reminding function is activated, the advanced-reminding is deleted.

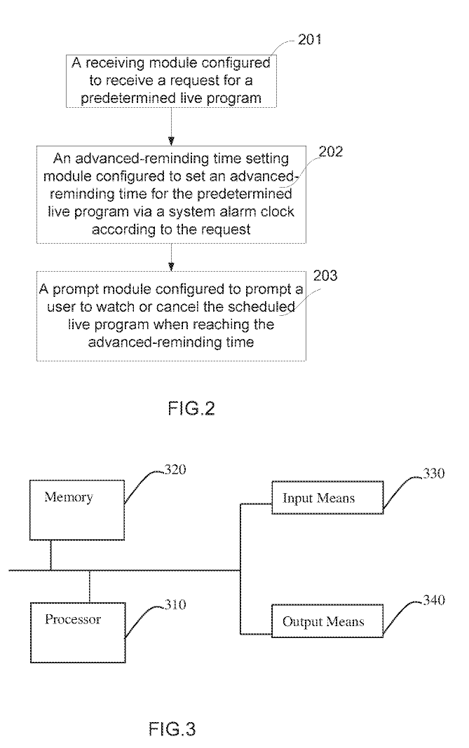

FIG. 2 is a block diagram of one embodiment of a device for reminding appointment of live programs of the present application. As illustrated in FIG. 2, the device for achieving a function of reminding appointment of live programs of the present application includes a receiving module 201, an advanced-reminding setting module 202, and a prompt module 203.

The receiving module 201 according to one embodiment of the device for reminding appointment of live programs of the preset application is configured to receive a request of a predetermined program. A user may set the predetermined program via a program list on a user terminal, including setting information of the predetermined program. The user information refers to account information of a user having logged in the user terminal, and the account information may include a mobile phone number of the user and the like. The information of the predetermined program includes a name and a play time of the predetermined program, as well as a channel playing the predetermined program, etc. After receiving the request initiated by the user, the terminal may confirm which program the user wishes to watch. The user terminal may be a wireless terminal or a wired terminal, wherein the wireless terminal may refer to a device having a wireless connection function, or a device connecting to a wireless modem and providing a voice and/or data communication to a user. The wireless terminal may carry out communications with one or more core networks through a wireless access network. The wireless terminal may be a mobile terminal, such as a mobile phone (or called as a “honeycomb” phone) and a computer having a mobile terminal. For instance, it may be a portable, pocket-sized, handheld, computer built-in or vehicle-mounted mobile device.

The advanced-reminding time setting module 202 according to one embodiment of the device for reminding appointment of live programs of the present application is configured to set an advanced-reminding time for a predetermined live program via a system clock according to the request. In particular, the setting of the advanced-reminding in the present application is specifically achieved via the system alarm clock, which may fully utilize the resources of the system, without the need for installing an additional application. Therefore, the memory consumption of the system is saved and the wasting of resources is avoided. In addition, the reminding time of the predetermined program is confirmed according to the information of the predetermined program (for instance, the name, the play time and the like thereof). The reminding time of the predetermined program refers to a specific time before the predetermined program play time, for instance, the reminding time is set as two minutes before the predetermined program play time. During the specific operation, the user sets the predetermined program via a terminal, and the terminal will automatically determine the reminding time of the predetermined program. For instance, with regard to a predetermined program “Super Brain” having a play time at 20:30 on Dec. 21, 2015, the user may select the predetermined program “Super Brain” via a terminal according to a program list, and the terminal will determine the reminding time of the predetermined program according to the information thereof after receiving the predetermined request. For instance, the terminal is automatically set to carry out the predetermined reminder at 20:28 via the system alarm clock according to the predetermined information after receiving a request of scheduling the “Super Brain” having a play time at 20:30 on December 21 by the user. In one embodiment of the present application, the reminder of the predetermined program may be executed in the forms of a ring tone, a vibration, displaying prompt message on a display screen, or sending the prompt message to a user's terminal (for instance, a mobile phone), wherein the prompt message, for instance, may include a name, a play channel and a play time and the like of the predetermined program. The combination of at least two of the above-mentioned forms, of course, may also be employed for conducting reminder.

In addition, the information of the predetermined program and the setting of the advanced-reminding are stored in a memory. To be specific, the user information, and the information and reminding time of the predetermined program are stored in the memory. The memory may refer to various apparatuses or devices, which may access programs or data and may also automatically access programs or data at a high speed in the running process.

The prompt module 203 according to one embodiment of the device for achieving a function of reminding appointment of live programs of the present application is configured to prompt a user to watch or cancel the predetermined live program when reaching the advanced-reminding time. To be specific, the advanced-reminding function is activated when reaching the reminding time of the predetermined program, so that a user may select to watch or cancel the predetermined program. For instance, with respect to the predetermined program having a play time at 20:30 on Dec. 21, 2015 and a set reminding time at 20:28 on Dec. 21, 2015, the advanced-reminding function is activated when the time reaches 20:28 on Dec. 21, 2015. If the user confirms to watch the predetermined program, the data is analyzed and the channel where the schedule program will be played is skipped to; while if the user cancels the watching of the predetermined program when the advanced-reminding function is activated, the advanced-reminding is deleted.

One embodiment of the present disclosure provides a nonvolatile computer-readable storage medium which stores executable instructions, wherein the method for reminding appointment of live programs according to any one embodiment as above can be performed by the executable instructions.

FIG. 3 is a hardware structure diagram of an electronic device for performing the method for reminding appointment of live programs according to one embodiment of the present disclosure.

As shown in FIG. 3, the electronic device includes one or more processors 310 and a memory 320. FIG. 3 takes one processor 310 as an example.

The electronic device for performing the method for reminding appointment of live programs may further include an input means 330 and an output means 340.

The processor 310, the memory 320, the input means 330 and the output means 340 may be connected via a bus or in other ways. In FIG. 3, these elements are connected via a bus.

The memory 320 can be used as a nonvolatile computer-readable storage medium, which can store a nonvolatile software program, a nonvolatile computer-executable program, and respective modules. For example, the medium stores program instructions/modules for performing the method for reminding appointment of live programs according to the embodiments of the present disclosure, such as the receiving module 201, the advanced-reminding setting module 202, and the prompt module 203. The processor 310 executes the nonvolatile software program, instructions and/or modules stored within the memory 320, so as to perform several functional applications and data processing, particularly, realize the method for reminding appointment of live programs according to the above embodiments as above.

The memory 320 may include a storage program zone and a storage data zone. The storage program zone may store an operating system and at least one application program for achieving respective functions. The storage data zone may store data created according to the usage of the device for reminding appointment of live programs. In addition, the memory 320 may further include a high speed random access memory and a nonvolatile memory, e.g. at least one of a disk storage device, a flash memory or other nonvolatile solid storage device. In some embodiments, the memory 320 may include a remote memory remotely located relative to the processor 310, and this remote memory may be connected, via a network, to the device for reminding appointment of live programs. For example, the network includes but is not limited within internet, intranet, local area network, mobile communication network and any combination thereof.

The input means 330 can receive digital or character information inputted, and generate a signal input associated with a user setting and a functional controlling of the device for reminding appointment of live programs. The output means 340 may include a display device such as a displaying screen.

One or more storage modules are stored within the memory 320. When said one or more storage modules are operated by one or more processors 310, the method for reminding appointment of live programs of the above embodiments is performed.

The products as above-mentioned may perform methods provided by the embodiments of the present disclosure, have functional modules for performing the methods, and achieve respective beneficial effects. For those technical details which are not mentioned in this embodiment, please refer to the methods provided by the embodiments of the disclosure.

The electronic device of the embodiment of the present disclosure may be constructed in several forms, which include but are not limited within:

(1) mobile communication device: this type of terminal has a function of mobile communication for main propose of providing a voice/data communication. This type of terminal includes: a smartphone (e.g. iPhone), a multimedia mobile phone, a feature phone, a low-end cellphone and so on;

(2) ultra mobile personal computer device: this type of terminal belongs to a personal computer which has a computing function and a processing function. In general, this type of terminal has a networking characteristic. This type of terminal includes: PDA, MID, UMPC and the like, e.g. iPad;

(3) portable entertainment device: this type of device can display and play multimedia contents. This type of device includes an audio/video player (e.g. iPod), a handheld game console, an electronic book, an intelligent toy, and a portable vehicle navigation device;

(4) server: the server provides a computing service. The construction of a server includes a processor, a hard disk, an internal memory, a system bus and so on, which is similar to the construction of a general computer but can provide more reliable service. Therefore, with respect to processing ability, stability, reliability, security, extendibility and manageability, a server has to meet a higher requirement; and

(5) other electronic devices having data interchanging functions.

It may be understood by those having ordinary skills in the art that the all or part flows of implementing the methods in the foregoing embodiments may be finished through relevant hardware instructed by a computer program. The program may be stored in a mobile device or a computer-readable storage medium, and the program while performing includes one or a combination of the flows of the embodiments according to the methods above. Wherein, the foregoing storage medium may be a magnetic disk, an optical disk, a Read-Only Memory (ROM) or a Random Access Memory (RAM), etc.

The above description is merely detailed implementation manner of this application, but not intended to limit the protection scope of this application. Any changes or replacements easily figured out by those skilled in the art without departing from the technical scope disclosed by this application shall all fall within the protection scope of this application. Therefore, the protection scope of this application shall be subjected to the protection scope of the claims.

What is claimed is:

1. A method for reminding appointment of live programs, applied at an electronic device, comprises the following steps:
receiving a request for a predetermined live program;
setting an advanced-reminding time for the predetermined live program via a system alarm clock according to the request; and
prompting a user to watch or cancel the predetermined live program when reaching the advanced-reminding time.

2. The method for reminding appointment of live programs according to claim 1, wherein the request comprises information related to a name, a play channel and a play time of the predetermined live program.

3. The method for reminding appointment of live programs according to claim 2, wherein prompting the user to watch or cancel the predetermined live program is achieved through at least one of the manners as follows: a ring tone, a vibration, displaying a prompt message on a display screen or sending a short message to a mobile phone of the user.

4. The method for reminding appointment of live programs according to claim 1, wherein prompting the user to watch the predetermined live program when reaching the advanced-reminding time specifically comprises: if the user confirms to watch the predetermined live program, interpreting data and skipping to a designated channel.

5. The method for reminding appointment of live programs according to claim 1, wherein prompting the user to cancel the predetermined live program when reaching the advanced-reminding time specifically comprises: if the user cancels the watching of the predetermined live program, deleting the advanced-reminding.

6. An electronic device, comprising:
at least one processor; and
a memory communicably connected with the at least one processor for storing instructions executable by the at least one processor, wherein execution of the instructions by the at least one processor causes the at least one processor to:
receive a request for a predetermined live program;
set an advanced-reminding time for the predetermined live program via a system alarm clock according to the request; and
prompt a user to watch or cancel the predetermined live program when reaching the advanced-reminding time.

7. The electronic device for reminding appointment of live programs according to claim 6, wherein the request comprises information related to a name, a play channel and a play time of the predetermined live program.

8. The electronic device for reminding appointment of live programs according to claim 7, wherein prompting the user to watch or cancel the predetermined live program is achieved through at least one of the manners as follows: a ring tone, a vibration, displaying a prompt message on a display screen or sending a short message to a mobile phone of the user.

9. The electronic device for reminding appointment of live programs according to claim 6, wherein prompting the user to watch the predetermined live program when reaching the advanced-reminding time specifically comprises: if the user confirms to watch the predetermined live program, interpreting data and skipping to a designated channel.

10. The electronic device for reminding appointment of live programs according to claim 6, wherein prompting the user to cancel the predetermined live program when reaching the advanced-reminding time specifically comprises: if the user cancels the watching of the predetermined live program, deleting the advanced-reminding.

11. A non-transitory computer-readable storage medium storing executable instructions that, when executed by an electronic device with a touch-sensitive display, cause the electronic device to:
receive a request for a predetermined live program;
set an advanced-reminding time for the predetermined live program via a system alarm clock according to the request; and
prompt a user to watch or cancel the predetermined live program when reaching the advanced-reminding time.

12. The non-transitory computer-readable storage medium according to claim 11, wherein the request comprises information related to a name, a play channel and a play time of the predetermined live program.

13. The non-transitory computer-readable storage medium according to claim 12, wherein prompting the user to watch or cancel the predetermined live program is achieved through at least one of the manners as follows: a ring tone, a vibration, displaying a prompt message on a display screen or sending a short message to a mobile phone of the user.

14. The non-transitory computer-readable storage medium according to claim 11, wherein prompting the user to watch the predetermined live program when reaching the advanced-reminding time specifically comprises: if the user confirms to watch the predetermined live program, interpreting data and skipping to a designated channel.

15. The non-transitory computer-readable storage medium according to claim 11, wherein prompting the user to cancel the predetermined live program when reaching the advanced-reminding time specifically comprises: if the user cancels the watching of the predetermined live program, deleting the advanced-reminding.
